(19) United States
(12) Patent Application Publication
(10) Pub. No.: US 2017/0216845 A1
(43) Pub. Date: Aug. 3, 2017

(54) ENHANCED COMPOSITE LIQUID CELL (CLC) DEVICES, AND METHODS FOR USING THE SAME

(71) Applicants: Becton, Dickinson and Company, Franklin Lakes, NJ (US); GenCell Biosystems Ltd., Raheen (IE)

(72) Inventors: Brian Chawke, Askeaton (IE); Jeffrey Sugarman, Los Altos, CA (US); James Nealis, Apex, NC (US); Jeffrey P. Baker, Durham, NC (US); Mark Dalton, Limerick (IE); John D. DeNuzzio, Monkton, MD (US); Emma M. Kelly, Waterford (IE); Mitchell E. Gatesman, Morrisville, NC (US)

(21) Appl. No.: 15/403,003

(22) Filed: Jan. 10, 2017

Related U.S. Application Data
(60) Provisional application No. 62/288,085, filed on Jan. 28, 2016.

(51) Int. Cl. B01L 7/00; B01J 19/00

(52) U.S. Cl. CPC B01L 7/525; B01J 19/0046; B01J 2219/00495; B01J 2219/00716; B01J 2219/00722; B01L 2300/1827; B01L 2300/185; B01L 2300/1894

(57) ABSTRACT

Enhanced composite liquid cell (CLC) devices and methods of using the same are provided. The devices find use in, among other applications, CLC mediated nucleic acid library generation protocols, e.g., for use in next generation sequencing applications.

### CROSS-REFERENCE TO RELATED APPLICATION

Pursuant to 35 U.S.C. §119(e), this application claims priority to the filing date of U.S. Provisional Patent Application No. 62/288,085, filed Jan. 28, 2016; the disclosure of which application is herein incorporated by reference.

### INTRODUCTION

Composite liquid cell (CLC) technology is a platform technology that is highly suitable for carrying out precise biochemical reactions in small working volumes. A composite liquid cell is small-volume roughly spherical structure having a core made up of an aqueous medium encapsulated by liquid shell of a medium immiscible with the core aqueous medium. In practice, the liquid cell is present on the free surface of a third carrier fluid that is mutually immiscible with both the core and encapsulating mediums, e.g., in a node of a thermal chip module. Aspects of the Composite liquid cell (CLC) platform technology are further described, e.g., in U.S. Pat. No. 8,465,707, as well as United States Patent Publication Nos. 20140371107, 20150238920 and 20150283541; and PCT Application Publication Nos. WO 2014/188281; WO 2014/207577; WO2015/075563 and WO2015/075560; the disclosures of which are herein incorporated by reference.

Practical applications of CLC technology include applications where a series of reactions are sequentially carried out, e.g., in chemical synthesis applications. For example, CLC technology finds use in the production of nucleic acid libraries for next generation sequencing (NGS). Library preparation is a process by which an initial, e.g., genomic, nucleic acid sample is prepared for analysis via next generation sequencing. At present, next-generation platforms use slightly different methodologies such as pyro-sequencing, sequencing by synthesis or sequencing by ligation. Most platforms, however, require nucleic acid preparations prior to sequencing. Typical steps include fragmentation (sonication, nebulization or shearing), followed by DNA repair and end polishing (blunt end or A overhang) and, finally, platform-specific adaptor ligation. Even for today's state-of-the-art sequencers a relatively high local concentration of the target molecule is required to sequence accurately. To streamline a particular workflow, automated machinery must overcome the challenges associated with automating and miniaturizing a series of processes aimed at modifying and amplifying nucleic acid content. This biochemistry process is generally performed in 96 or 384 static well plates with typical volumes ranging from 10 microliters to 200 microliters.

### SUMMARY

Enhanced composite liquid cell (CLC) devices and methods of using the same are provided. Aspects of the enhanced devices include: a thermal chip module comprising multiple nodes; a plate location; and a robotically controlled liquid handler configured to transfer liquid between the plate location and the thermal chip module. The devices further include one or more of the following aspects: (a) the robotically controlled liquid handler includes a fluid pump operably coupled to a manifold, wherein the manifold is configured to split a first fluid conduit from the fluid pump into multiple fluid channels and includes a flow restrictor for each of the multiple fluid channels; (b) the thermal chip module includes a substantially planar top surface and an inwardly tapered, e.g., dual-tapered, bottom surface; and (c) the thermal chip module includes a thermal fluid tube array, wherein: (i) the thermal fluid tube array includes a first fluid inlet and a second fluid inlet and a first fluid outlet and a second fluid outlet; and/or (ii) the thermal fluid tube array is operably connected to a fluid bath system configured to control the temperature of fluid flowing into the thermal fluid tube array, wherein the fluid bath system includes a cooling fluid bath and: (1) a second thermal fluid bath operably coupled with the thermal fluid tube array, wherein the second thermal fluid bath is maintained at temperature higher than the cooling fluid bath; and/or (2) a flow through heater operably coupled with the cooling fluid bath. The devices find use in, among other applications, CLC mediated nucleic acid library generation protocols, e.g., for use in next generation sequencing applications.

### BRIEF DESCRIPTION OF THE FIGURES

The invention may be best understood from the following detailed description when read in conjunction with the accompanying drawings. Included in the drawings are the following figures:

FIG. 1A-1B show a schematic of (FIG. 1A) a single-taper thermal chip module and (FIG. 1B) a dual-tapered thermal chip module.

FIG. 2A-2B show steady-state temperature simulations at a 95° C. hold temperature for (FIG. 2A) a single-taper thermal chip module (ΔT=1.8° C.), and (FIG. 2B) a dual-tapered thermal chip module (ΔT=1.0° C.).

FIG. 3A-3B show a schematic of (FIG. 3A) a single inlet/outlet coolant path, and (FIG. 3B) a double inlet/outlet coolant path.

FIG. 4A-4B show simulated results displaying temperature map of a single-taper thermal chip module at 7 seconds into the cooling cycle with (FIG. 4A) a single inlet/outlet coolant path, and (FIG. 4B) a double inlet/outlet coolant path.

FIG. 5A-5B show a thermal image of a dual-taper thermal chip module at 5 seconds into cooling with (FIG. 5A) a single inlet/outlet coolant path, and (FIG. 5B) a double inlet/outlet coolant path.

FIG. 6A-6B show thermocouple traces of PCR cycle for (FIG. 6A) a single coolant bath system, and (FIG. 6B) dual coolant bath system.

FIG. 7 shows a schematic of a dual fluid bath system for a single thermal chip module.

FIG. 8 shows a schematic of one embodiment of improved purification fluidics of a fluid purification system.

FIG. 9 shows a schematic of one embodiment of improved purification fluidics of a fluid purification system.

### DETAILED DESCRIPTION

Enhanced CLC devices and methods of using the same are provided. Aspects of the enhanced devices include: a thermal chip module comprising multiple nodes; a plate location; and a robotically controlled liquid handler configured to transfer liquid between the plate location and the thermal chip module. The devices further include one or more of the following aspects: (a) the robotically controlled liquid handler includes a fluid pump operably coupled to a manifold, wherein the manifold is configured to split a first fluid conduit from the fluid pump into multiple fluid channels and includes a flow restrictor for each of the multiple fluid channels; (b) the thermal chip module includes a substantially planar top surface and an inwardly tapered, e.g., dual-tapered, bottom surface; and (c) the thermal chip module includes a thermal fluid tube array, wherein: (i) the thermal fluid tube array includes a first fluid inlet and a second fluid inlet and a first fluid outlet and a second fluid outlet; and/or (ii) the thermal fluid tube array is operably connected to a fluid bath system configured to control the temperature of fluid flowing into the thermal fluid tube array, wherein the fluid bath system includes a cooling fluid bath and: (1) a second thermal fluid bath operably coupled with the thermal fluid tube array, wherein the second thermal fluid bath is maintained at temperature higher than the cooling fluid bath; and/or (2) a flow through heater operably coupled with the cooling fluid bath. The devices find use in, among other applications, CLC mediated nucleic acid library generation protocols, e.g., for use in next generation sequencing applications.

Before the present invention is described in greater detail, it is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Certain aspects of composite liquid cells and devices for manipulating them are described in U.S. Pat. No. 8,465,707, as well as United States Patent Publication Nos. 20140371107, 20150238920 and 20150283541; and PCT Application Publication Nos. WO 2014/188281; WO 2014/207577; WO2015/075563 and WO2015/075560. While the present disclosure provides modifications to components and systems of these CLC devices, such modifications are applicable to other non-CLC based devices.

### Devices

As summarized above, aspects of the invention include improved components and systems for use in complete, compact nucleic acid library preparation devices. As the devices are complete nucleic acid library preparation devices, they include all components necessary to prepare a nucleic acid library from an initial nucleic acid sample, e.g., a nucleic acid library suitable for next generation sequencing (NGS). Accordingly, certain embodiments of the devices are configured such that an initial nucleic acid sample can be introduced into the device and a complete nucleic acid library ready for use in a NGS protocol can be obtained from the device, with little if any user interaction with the device between the time of sample introduction and product NGS library retrieval. The devices include all liquid handling and other components necessary to produce a nucleic acid library, as reviewed in greater detail below. The devices are automated, in that they are configured so that at least some, if not all, steps of a given library preparation protocol may occur without human intervention, beyond introduction of the nucleic acid sample into the device, loading of any requisite reagents and input of information, and activating the device to produce the nucleic acid library from the nucleic acid sample. Steps of a nucleic acid production protocol that may be automated in the devices include, but are not limited to: liquid transfer steps, reagent addition steps, thermal cycling steps, product purification steps, etc.

In some instances, the devices are compact. By “compact” is meant that the device is dimensioned to be positioned on a bench top or table top in a research laboratory environment. In some instances the device has a length ranging from 0.5 to 4 meters, such as 1 to 2 meters, e.g., 1.54 meters; a width ranging from 0.25 to 1.75 meters, such as 0.5 to 1 meter, e.g., 0.805 meters; and a height ranging from 0.5 to 2 meters, such as 0.75 to 1.25 meters, e.g., 0.885 meters. The weight of the device may vary, and in some instances ranges from 100 to 300 kg, such as 150 to 200 kg, e.g., 180 kg.

For additional descriptions of nucleic acid library preparation devices, see U.S. Pat. No. 8,465,707, as well as United States Patent Publication Nos. 20140371107, 20150238920 and 20150283541; and PCT Application Publication Nos. WO 2014/188281; WO 2014/207577; WO2015/075563 and WO2015/075560; the disclosures of which are herein incorporated by reference.

In certain embodiments, a complete nucleic acid library preparation device according to aspects of the present disclosure includes: a thermal chip module having multiple nodes; a plate location; and a robotically controlled liquid handler configured to transfer liquid between the plate location and the thermal chip module; where the device further includes one or more of the following:

(a) the robotically controlled liquid handler includes a fluid pump operably coupled to a manifold, wherein the manifold is configured to split a first fluid conduit from the fluid pump into multiple fluid channels and includes a flow restrictor for each of the multiple fluid channels;

(b) the thermal chip module includes a substantially planar top surface and a dual-tapered bottom surface; and

(c) the thermal chip module includes a thermal fluid tube array, where (i) the thermal fluid tube array includes a first fluid inlet and a second fluid inlet and a first fluid outlet and a second fluid outlet; and/or (ii) the thermal fluid tube array is operably connected to a fluid bath system configured to control the temperature of fluid flowing into the thermal fluid tube array, where the fluid bath system includes a cooling fluid bath and either one or both of (1) a second thermal fluid bath operably coupled with the thermal fluid tube array, wherein the second thermal fluid bath is maintained at temperature higher than the cooling fluid bath; and (2) a flow through heater operably coupled with the cooling fluid bath.

These aspects are now reviewed in greater detail.

### Thermal Chip Module

As summarized above, devices described herein include a thermal chip module. The devices may include a single thermal chip module, or two or more thermal chip modules, e.g., two thermal chip modules. Thermal chip modules are plate or chip type structures that include one or more nodes, where each node is configured to accommodate a CLC on a surface of a carrier liquid positioned at the bottom of the node. Each node may be open at the top to provide for liquid access to a CLC present in the node. The volume defined by a given node of a thermal chip module may vary, and in some instances ranges from 2 μl to 1 ml, such as 5 μl to 20 μl. The cross-sectional shape of a given node may also vary, where cross-sectional shapes of interest include, but are not limited to, circular, rectangular (including square), triangular, etc. While the dimensions of each node may vary, in some instances the nodes have a longest cross-sectional dimension (e.g., diameter) ranging from 1 mm to 25 mm, such as 2.5 mm to 10 mm and a depth ranging from 1 mm to 20 mm, such as 3 to 10 mm. The number of nodes present in a given thermal chip module may also vary, ranging in some instances from 1 to 2000, such as 10 to 768. In some embodiments, the number of nodes is 96 or 384, e.g., in embodiments where correspondence with conventional multi-well plates is desired.

Thermal chip modules include, in some instances a node-defining base plate made of a convenient material and configured to define the nodes of the module. While the node-defining base plate may be made of any convenient material, in some instances the node-defining base plate is made of thermally conductive material. Materials of interest include, but are not limited to thermally conductive materials, e.g., composites, ceramics, and metals, including aluminum. While the dimensions of the node-defining plate may vary, in some instances the node-defining plate has a length ranging from 10 mm to 400 mm, such as 10 mm to 200 mm cm; a width ranging from 10 mm to 400 mm, such as 10 mm to 200 mm cm and a height ranging from 1 mm to 20 mm, such as 3 mm to 10 mm.

As mentioned above, each node defined by the node-defining plate is configured to accommodate a carrier liquid for a CLC at its bottom portion. While a given plate may have nodes with a closed bottom, such that during use an amount of carrier liquid is individually positioned at the bottom of each node, in some instances the chip module is configured such that the nodes are open at their bottom to provide for a common carrier liquid in each node. In some instances, the node-defining plate is operably coupled to a base or vessel portion, sized and shaped to contain a bath of carrier liquid such that each node has the same level of carrier liquid present in its bottom portion. The carrier liquid may have a free surface on which CLCs may be accommodated. Like the node-defining plate, the vessel can be highly thermally conductive, e.g., composites, ceramics, and metals, in particular, aluminum, so that heat applied to the vessel will be spread evenly through the carrier liquid and into the CLCs. An aspect of the thermal chip modules is that they are thermally controlled, such that the temperature of the environment defined by each node (and therefore experienced by a CLC accommodated therein) may be controlled, e.g., including precisely controlled, e.g., to a tenth of degree or better. The range of temperature control may vary, where in some instances the temperature may be controlled between 4 to 120° C., such as 4 to 98° C.

In certain embodiments, the thermal chip module has a substantially flat (or planar) top surface that is level as compared to the surface of the carrier liquid and a bottom surface that is tapered (or sloped) in at least one direction. In use in a CLC device, the bottom surface of the thermal chip module is in contact with (or submerged in) the carrier fluid while the top surface is not (it is exposed to the air). In other words, the top surface of the thermal chip module is positioned above the top surface of the carrier liquid and the bottom surface of the thermal chip module is positioned below the top surface of the carrier liquid. The tapered bottom surface of the thermal chip module provides a way to prevent bubbles (e.g., air bubbles formed during thermocycling) from becoming trapped under the thermal chip module. Specifically, the tapered bottom allows air bubbles to travel along the taper to the edge of the thermal chip module. This allows for continuous contact between the bottom surface of the thermal chip module and the carrier liquid, ensuring full priming of the carrier liquid into all nodes in the module.

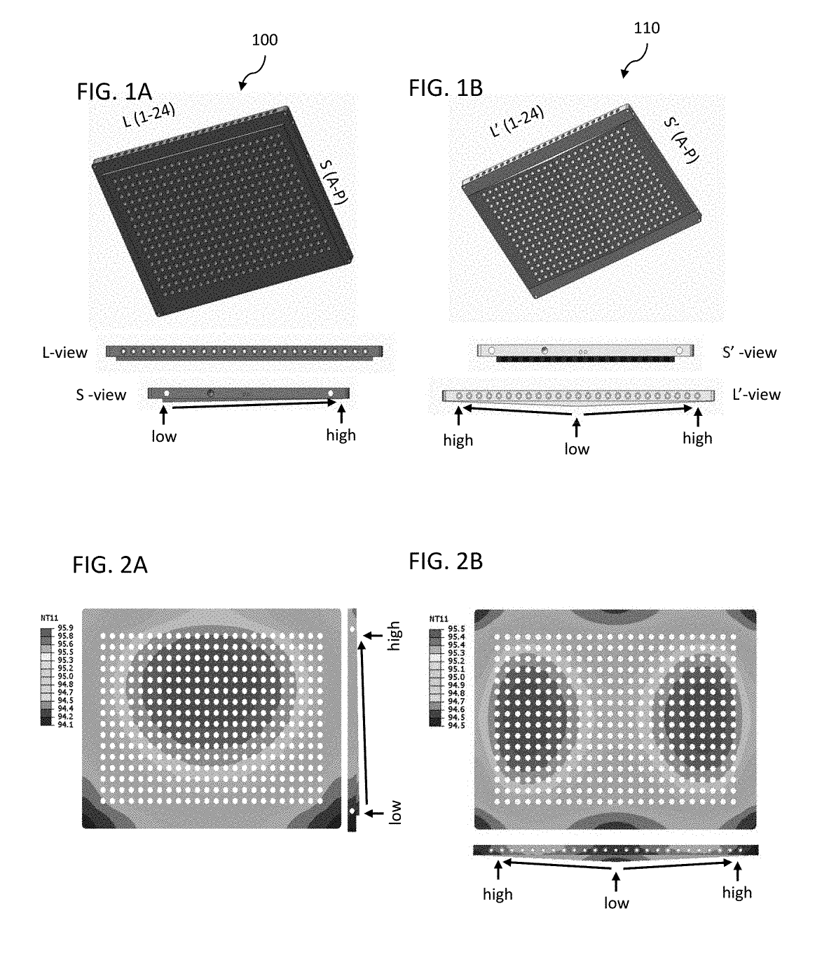

In certain embodiments, the thermal chip module contains a single taper feature on the bottom surface, e.g., as shown in FIG. 1, panel A. FIG. 1, panel A shows thermal chip module 100 having an array of 384 nodes (24×16 nodes; long side (L) is 24 wells long; short side (S) is 16 wells long). The bottom surface of thermal chip module 100 is visible in the top view of FIG. 1A. Views from the L and S sides of thermal chip module 100 are also shown (L-view and S-view). The taper in this thermal chip module can be seen in the S-view, with the low end of the taper on the left (“low”) and the high end of the taper on the right (“high”). In this configuration, bubbles that collect underneath the thermal chip module, e.g., during thermal cycling, travel from the left side of the S view to right (in the direction of the arrow).

While this single-taper configuration of the bottom surface is effective in preventing accumulation of bubbles underneath the thermal chip module, in some instances it may result in the creation of a notable ‘hot spot’ when heated by the resistive heater mat due to the distribution of thermal mass (see the thermal simulation in FIG. 2, panel A).

In order to reduce the creation of this hot spot, a thermal chip module may have an inwardly tapered bottom surface. By “inwardly tapered bottom surface” is meant that the bottom surface includes a region inward from the edges which extends above the plane defined by the edges of the bottom surface, such that an inner region of the bottom surface extends below the edges of the bottom surface which viewed from the side. The region inward from the edges which extends above the plane defined by the edges of the bottom surface may be centrally located or located to one or more sides of the center of the bottom surface, as desired. Inwardly tapered bottom surfaces may have a variety of different configurations, including but not limited to, conical configurations, pyrimidal configurations, multi-tapered, e.g., dual-tapered configurations, e.g., wherein the bottom surface is a dual tapered bottom surface, e.g., as shown in FIG. 1, panel B. By “dual taper” is meant that the bottom surface slopes from opposing sides to a region between, e.g., the center, of the bottom surface. FIG. 1, panel B shows thermal chip module 110 having an array of 384 nodes (24×16 nodes; long side (L') is 24 wells long; short side (S') is 16 wells long). The bottom surface of thermal chip module 110 is visible in the top view in FIG. 1B. Views from the L' and S' sides of thermal chip module 110 are also shown (L'-view and S'-view). The dual-taper in this thermal chip module can be seen in the L'-view, with the low end of the taper in the center (“low”) and the high ends of the taper on the left and right (“high”). In this configuration, bubbles that collect underneath the thermal chip module travel from the center of the L' side to the edges (in the direction of the arrows). This dual-taper feature optimizes the thermal mass of the block and improves thermal uniformity while still allowing for air bubbles to be directed away during operation. While the dual-taper design was intended to reduce the overall temperature gradient and spread the thermal epicenter throughout the block, a thermal simulation predicted two symmetric thermal epicenters in the dual-taper configuration. See FIG. 2 panel B for the simulation results.

In addition to the dual-taper feature, the mass of the thermal chip module can be increased to improve uniformity during both steady state and temperature transitions, e.g., by increasing the thickness of the thermal chip module (e.g., increasing the thickness by 2 mm). Alternatively, or in addition to, increasing the mass, the thermal chip module can be fabricated with a material having a different heat capacity. For example, switching the thermal block material from aluminum to copper can provide uniformity improvements. While we initially had concern over an expected decrease in the temperature ramp rate by increasing the thermal mass of the thermal chip module, our testing demonstrated that there was no negative impact to the assays performed on the system due to of the slower ramp rates.

In certain embodiments, the thermal chip module includes nodes for the retention of the Composite Liquid Cells (CLC) and an embedded thermal fluid tube array to allow the flow of a fluid at a desired temperature throughout the block (e.g., a cooling fluid (coolant), a heating fluid, or a fluid to maintain a target temperature for an incubation step). In certain embodiments, the fluid tube array is in fluid communication with a thermal fluid flow system that controls the temperature and flow rate of thermal fluid there-through.

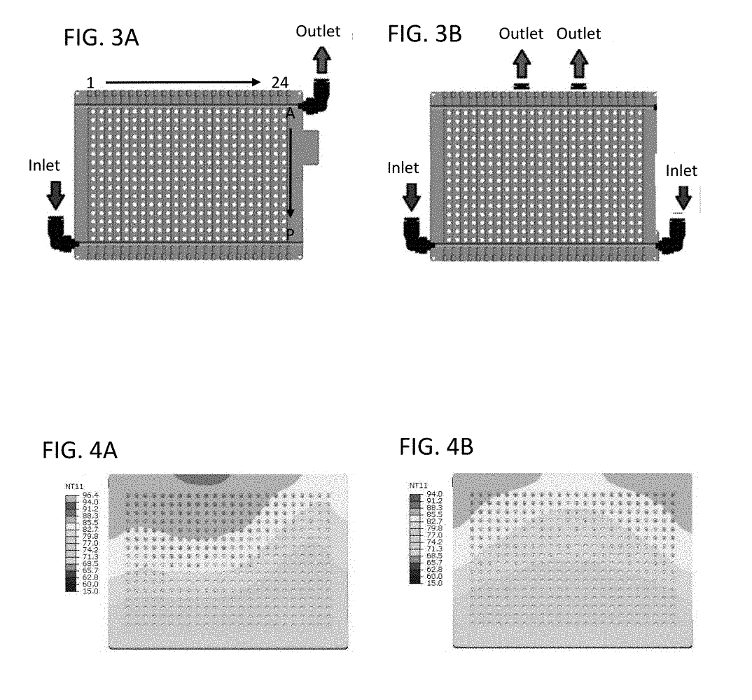

Flowing thermal fluid through the thermal tube array can be achieved in any convenient manner. In certain embodiments, the thermal fluid enters the thermal fluid tube array via a single inlet port and exits from a single outlet port, e.g., as depicted in FIG. 3A. In this figure, thermal fluid from a thermal fluid flow system (not shown) flows into the thermal fluid tube array through an inlet located at a terminal end of an exterior row of the thermal fluid tube array (at the bottom left in FIG. 3A) and exits from an outlet located on the opposite terminal end of the opposite exterior row. In standard micro-well plate nomenclature, the thermal fluid tube array inlet in this embodiment would be near the P1 node of the thermal chip module and the outlet would be near the A24 node.

A thermal simulation of thermal chip module with a dual-taper bottom surface and the single inlet/outlet configuration for the thermal fluid tube array showed uneven heat distribution (FIG. 4 panel A). In order to improve the thermal profile, a thermal fluid tube array having two inlet ports and two outlet ports was designed and tested. As shown in FIG. 3 panel B, this dual inlet/dual outlet system has a first fluid inlet and a second fluid inlet positioned at opposite ends of a single exterior row of the thermal fluid tube array (adjacent to node positions P1 and P24 in standard micro-well nomenclature). The first fluid outlet and the second fluid outlet in this embodiment are positioned on the side opposite the exterior row with the inlets (or the distal end) at the end of corresponding first and second columns of the thermal fluid tube array (the column between rows 9 and 10 of the nodes and the column between rows 16 and 17 of the nodes in standard micro-well nomenclature). This configuration effectively splits the thermal block into two smaller blocks for the cooling cycles and allows for increased cooling/heating rate and increase uniformity of the block temperature during a cooling/heating cycle (see thermal simulation in FIG. 4 panel B). In these instances, the distance between each outlet may vary, ranging in some instances from 4.5 to 108 mm, such as 22.5 to 45 mm, where the distance of each outlet from the side of the array may also vary, ranging in some instances from 4.5 to 54 mm, such as 31.5 to 54 mm.

Simulations of the thermal fluid velocity through a thermal fluid tube array having a single fluid inlet/outlet configuration show that the center of the thermal fluid tube array has the lowest velocity and the vertical edges have the highest velocity (data not shown). The formation of two thermal epicenters seen with the dual-taper thermal chip module design (e.g., as shown in FIG. 2, panel B) may be advantageous, especially with a single inlet/outlet coolant path, as the velocity of a coolant fluid would be higher near the two thermal epicenters.

Simulations of the thermal fluid velocity through a thermal fluid tube array having a double inlet/outlet configuration show a more uniform fluid flow through the thermal fluid tube array (data not shown). Specifically, the fluid flow through the columns of the fluid tube array in the dual inlet/outlet configuration of FIG. 3, panel B is more uniform than in the single inlet/outlet configuration of FIG. 3A (i.e., the fluid tubes running from bottom row P to top row A in FIG. 3).

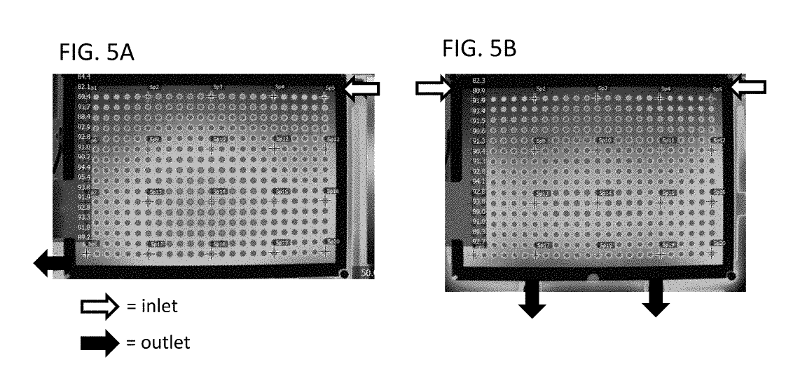

The effect of inlet/outlet configuration of a thermal fluid tube array on the cooling of a dual-taper thermal chip module was assessed. Thermal chip modules having single and double inlet/outlet configurations were raised to a temperature of 95° C. after which a thermal fluid at 57° C. was flowed through the thermal fluid tube array. Thermal images were taken after 5 seconds of cooling fluid flow and are shown in FIG. 5 (the fluid inlets and outlets are indicated). As is clear from this Figure, the dual inlet/outlet configuration (FIG. 5 panel B) shows increased cooling of the thermal chip module over the single inlet/outlet configuration (FIG. 5 panel A) as well as a more uniform thermal profile of the thermal chip module.

It is noted here that any convenient number of thermal fluid inlets and/or outlets can be employed to flow thermal fluid through a thermal fluid tube array of the present disclosure (i.e., the number of inlets/outlets is not limited to the single or double configurations described above). Moreover, the number of fluid inlets does not necessarily have to match the number of fluid outlets. For example, a thermal fluid tube array of a thermal chip module can have 2 inlets positioned at opposite ends of an external row of the thermal tube array and 4 outlets positioned on the opposite side on 4 different columns of the thermal tube array (e.g., equidistant from each other). Thus, a thermal fluid tube array can include from 1 to 20 (or more) fluid inlets, e.g., 1, 2, 3, 4, 5, 6, 7, 8, 9, 10, 11, 12, 13, 14, 15, 16, 17, 18, 19, 20 or more inlets. A thermal fluid tube array can include from 1 to 20 (or more) fluid outlets, e.g., 1, 2, 3, 4, 5, 6, 7, 8, 9, 10, 11, 12, 13, 14, 15, 16, 17, 18, 19, 20 or more outlets.

The thermal cooling/heating rate of a thermal chip module can be increased in other ways. For example, incrementally increasing the thermal fluid flow rate through the thermal tube array will lead to more rapid temperature changes. In addition, (and as noted above), the composition of the thermal chip module can be changed to materials that have increased heat capacity (e.g., from aluminum to copper).

As detailed in this section, the use of a dual-tapered feature on the thermal chip module balances the thermal mass more evenly than a single-taper system and improves the temperature uniformity of the thermal chip module in steady state. The use of multiple inlets and outlets for flowing thermal fluid through the thermal fluid tube array also improves the uniformity of the thermal chip module, e.g., during cooling. It was unexpected to find that in both simulated and real-world analyses that increasing the thermal mass of the thermal chip module (i.e., going from a single-taper to a dual-taper configuration) did not result in significant increases in the thermal ramp rate during cooling.

### Thermal Fluid Flow System

As indicated above, certain embodiments of the devices disclosed herein include a thermal fluid flow system in fluid communication with the thermal fluid tube array of the thermal chip module. The thermal fluid flow system is configured to flow thermal fluid at a pre-determined temperature and flow rate through the thermal fluid tube array, i.e., from the inlet(s) to the outlet(s) (as described above). A thermal fluid flow system generally includes at least one thermal fluid, at least one thermal fluid temperature control element, and at least one thermal fluid flow rate control element. In certain embodiments, at least one thermal fluid temperature control element includes a thermal fluid bath system, where the thermal fluid bath system is configured to control the temperature of fluid flowing into the thermal fluid tube array using at least one thermal fluid bath held at a pre-determined temperature. Thermal fluid from a thermal fluid bath can be flowed, using a thermal fluid flow rate control element, to the thermal fluid tube array of the thermal chip module to regulate (or modulate) its temperature.

In certain embodiments, the thermal fluid bath is a cooling fluid bath, where in certain embodiments the temperature of the thermal fluid in the cooling fluid bath is from 10° C. to 30° C., e.g., 10° C., 12° C., 14° C., 16° C., 18° C., 20° C., 22° C., 24° C., 26° C., 28° C., 30° C., or any temperature there between.

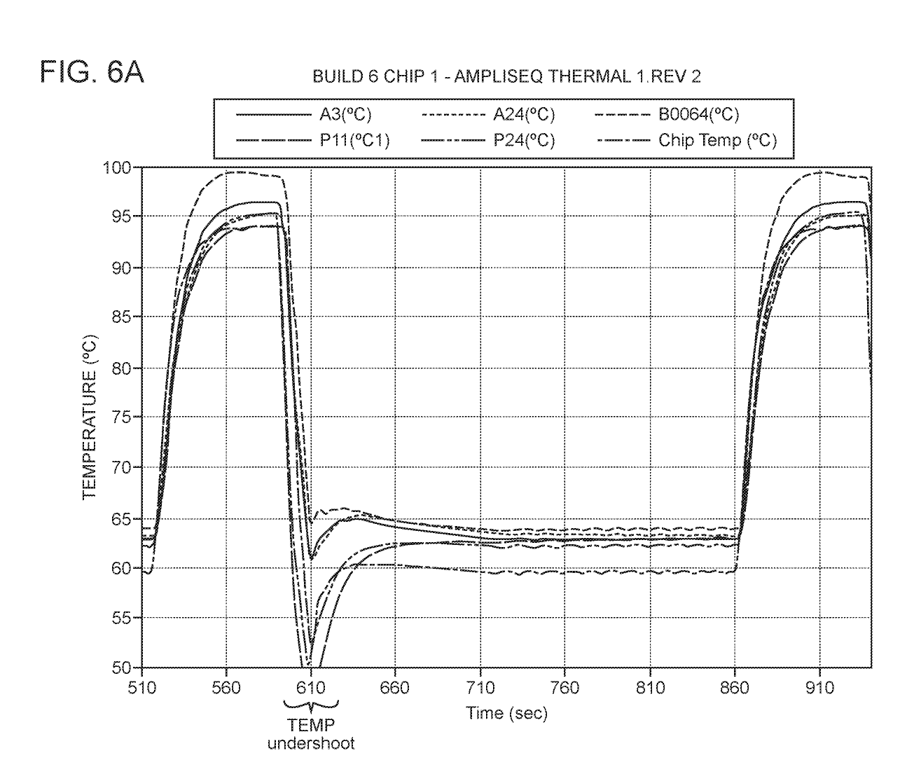

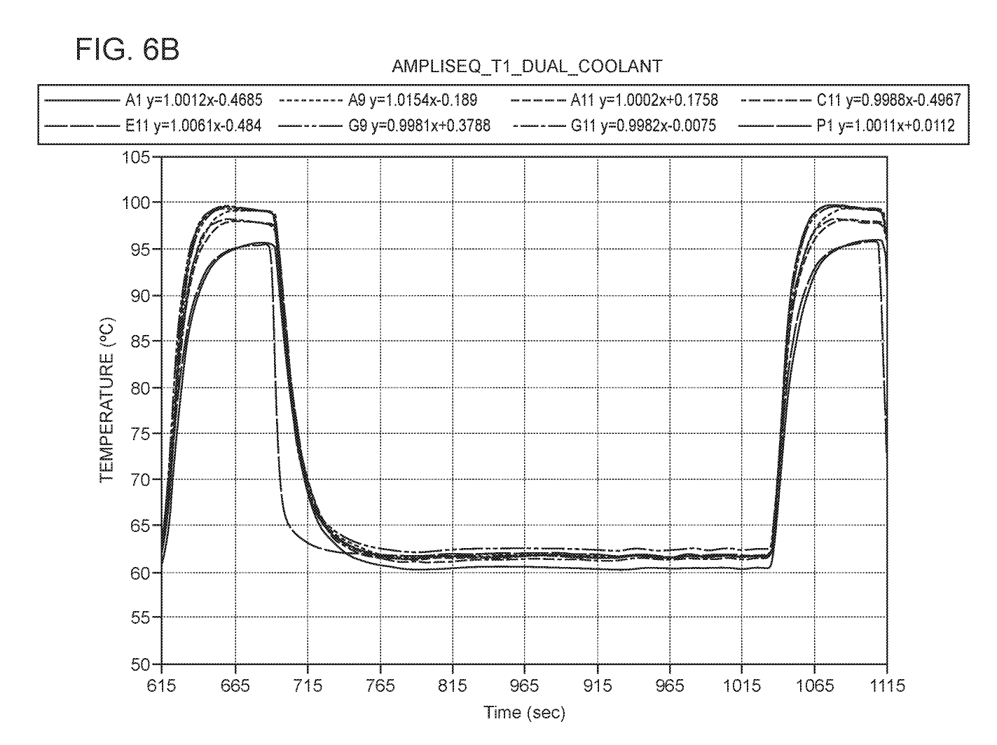

In testing systems having a single cooling thermal fluid bath to cool the thermal chip module from a higher temperature incubation step to a lower temperature incubation step, it was found that significant temperature undershoot occurred (i.e., where the temperature in the nodes of the thermal chip module dropped below the desired target temperature for the lower incubation step). Temperature undershoot arose, for example, during PCR cycles when the temperature of the thermal chip module was programmed to drop from 95° C. to 60° C. by flowing a thermal fluid from a thermal fluid bath held at 10° C. of the thermal fluid bath system through the thermal chip module until the temperature reaches (or nearly reaches) the target incubation temperature of 60° C. The temperature undershoot observed when using the single bath system is shown in FIG. 6, panel A, which traces the temperature profile over time of multiple nodes in a thermal chip module during a first heating step, a rapid cooling and incubation step (during the rapid cooling, cooling fluid is flowed through the thermal fluid tube array), and a second heating step. The temperature undershoot is indicated.

In order to eliminate (or significantly reduce) temperature undershoot, a second thermal fluid bath was included as part of the in the thermal fluid bath system. This second thermal fluid bath was at a temperature that was higher than the cooling fluid bath. In this case, the second thermal fluid bath was at a temperature identical to the desired incubation temperature (in this case, 60° C.). During the cooling step, the thermal fluid bath system is programmed to flow cooling fluid (at 10° C.) through the thermal chip module until the temperature reaches (or nearly reaches) the target incubation temperature or 60° C. The thermal fluid bath system then flows thermal fluid from the second fluid bath at 60° C. through the thermal chip module to prevent thermal undershoot. At this time, the thermal fluid bath system can be used to maintain the incubation temperature or a separate thermal control system can be employed, as described above (or a combination of both). As shown in FIG. 6, panel B, temperature undershoot was essentially eliminated using the dual-bath thermal fluid bath system as described above.

Devices disclosed herein can thus include, in certain embodiments, a thermal fluid bath system that includes a first fluid bath held at a low temperature (a cooling fluid bath), e.g., from 10° C. to 30° C., and a second fluid bath at a temperature higher than the first bath, e.g., at least 30° C. higher than the first bath. In certain embodiments, the second fluid bath is from 55° C. to 95° C. In certain embodiments, the thermal fluid bath system includes more than two thermal fluid baths, each of which is at a different temperature. The number and temperatures of the fluid baths of the thermal fluid bath system will be based on the specific thermal cycling parameters needed to carry out the steps of the protocol. No limitation in this regard is intended.

The first and second fluid baths (and any additional fluid baths) of the thermal fluid bath system can be plumbed to allow switching between baths dependent on the assay to be run. In such embodiments, the thermal fluid bath system includes a controller configured to control fluid flow from the first and second fluid baths (or additional fluid baths) to the thermal fluid tube array of the thermal chip module based on a target temperature.

In certain embodiments, the thermal fluid bath system includes an inline mixer configured to mix fluids from the first (cooling) fluid bath and the second thermal fluid bath prior to entering the thermal fluid tube array. The inline mixer can be controlled by the controller, with the controller determining the proportion of the first and second fluids from the first and second fluid baths to be mixed by the inline mixer to obtain the desired temperature of thermal fluid to flow into the thermal fluid tube array. In certain embodiment, the controller includes a feedback control configured to control the proportion of fluids mixed by the inline mixer based on the measured temperature of the thermal chip module and the desired target temperature.

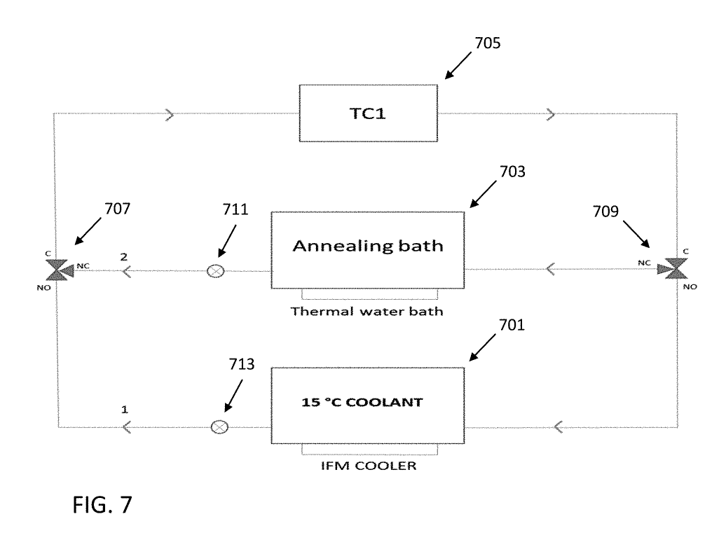

A schematic of one example of a thermal fluid bath system having two thermal fluid baths is shown in FIG. 7. The schematic in FIG. 7 shows a closed thermal fluid flow system that flows thermal fluid between a first bath 701 (“15° C. Coolant”) and a second bath 703 (“Annealing bath”) of a thermal fluid bath system and a first thermal chip module 705 (“TC1”). Direction of fluid flow is indicated by the arrowheads. Note that thermal fluid bath system can include more than two thermal fluid baths. In addition, the device can include more than one thermal chip module (not shown). In certain of these embodiments, the fluid flow to a first thermal chip module is controlled by the same controller as to the second thermal chip module whereas in other embodiments, the fluid flow to a first thermal chip module is controlled by a different controller that the fluid flow to the second thermal chip module. In addition, the thermal fluid flow to each thermal chip module can be controlled independently allowing for different target temperatures to be reached/maintained in each different thermal chip module. No limitation in this regard is intended.

The system shown in FIG. 7 also includes two inline mixers 707 and 709 with feedback control that regulate the fluid flow (through valves 711 and 713) so as to proportionally mix fluid form the first and second thermal fluid baths to reach a desired temperature. The fluid baths can be held at the desired temperature using any convenient heating/cooling bath systems (e.g., IFM cooler, thermal water bath, and the like).

In certain embodiments, the thermal fluid bath system includes a first thermal fluid bath (e.g., a cooling fluid bath) and a flow-through heater (not shown in FIG. 7) configured to heat fluid from the cooling fluid bath (and/or fluid from a second fluid bath, if present) prior to entering the fluid tube array of the thermal chip module. This flow-through heater can raise the temperature of the coolant in the supply lines prior to entering the thermal fluid tube array of the thermal chip module and function to prevent temperature undershoot in a manner similar to the second fluid bath (as described above). Control of the flow-through heater can be through feedback control, where temperature measurements of the thermal chip module and/or thermal fluid exiting the thermal tube array of the thermal chip module can be used to control thermal fluid heating by the flow-through heater (similar with the control of fluid flow from the first and second fluid baths).

In certain embodiments, the thermal fluid flow system described herein can replace other thermal block cooling systems, e.g., a Peltier cooling system. Providing a thermal fluid to the thermal chip module that is at a temperature equal to or near to the target temperature of a desired thermal hold minimizes temperature undershoot and is critical to performance.

It is noted that the use of a dual thermal fluid bath system, or a single fluid bath with a flow-through heater, as described above can improve temperature control of the thermal chip module during virtually temperature incubation step programmed into the device. For example, we found that a thermal fluid bath system using a single low temperature coolant did not allow for full control during a warm temperature hold. Specifically, the thermal chip module could be pulse heated directly to maintain temperature but there was no method to slightly cool the thermal block when the temperature rose above the target temperature; the cooling fluid bath temperature was too low to provide this functionality. However, the inclusion of a second fluid bath in the thermal fluid bath system set at a temperature slightly below the target incubation temperature (e.g., from 1 to 5° C. below the target incubation temperature) allows a user to flow thermal fluid in short pulses to the fluid tube array of the thermal chip module to provide active and precise cooling during the warm temperature holds. In this way, the second warm thermal fluid bath (and/or the flow-through heater) can replace the cooling functions of a Peltier cooler typically employed in conventional thermocyclers.

As described above, the thermal fluid bath system reduces/eliminates temperature undershoot in cooling phases by using a second thermal fluid bath with temperature that is near (but slightly below) a target incubation temperature (and/or using a flow-through heater to heat thermal fluid from a cooling fluid bath to this temperature). Careful design of the control algorithm to reach and hold the desired temperature allows for small variations and inaccuracies of the bath temperatures while minimizing the undershoot experienced during sensitive steps in the assays. This control allows for a product robust to inaccuracies in the measurement and control of the bath temperature as well as any ambient affects that may influence the temperature of the liquid coolant prior to entering the thermal block.

In addition to a thermal fluid flow system, the device disclosed herein may include additional heating and/or cooling elements for the thermal chip module. For example, the thermal chip module may include a cooling element configured to be operably attached to temperature modulator, e.g., a Peltier cooling system or a forced convection cooling system. The thermal chip module may also include a heating element in thermal contact with the vessel, e.g., an etched foil heater electrically connected to a controller, the controller being programmed to activate the heating element to generate a desired thermocycle in nodes and the CLCs accommodated therein. Alternatively, the heating element may be an electrical wire, activated by passing an electrical current through the wire. The wire may be electrically insulated with a material, for example, PTFE, that can also be used to form the stabilization features. In this embodiment, the heating element need not be in direct thermal contact with the vessel; the heat will be more directly transferred to the CLCs through the electrically insulating stabilization features. The stabilization features can be integral with the wire's insulation, and can be formed of the same material. Alternatively, the stabilization features can be attached to the wire, and/or made of a different material than the insulation. Such an embodiment may or may not also include nodes comprising the stabilization features. Stabilization features are further described in PCT application serial no. PCT/IB2014/001784 published as WO/2014/188281; the disclosure of which is herein incorporated by reference. Alternatively stabilization features may be present on only the module and not be integrated with the heating element. The heating element can be incorporated into the node-defining plate or vessel, or can be provided as a separate element of the module, e.g., as desired.

The thermal chip module can also be operatively coupled to a lid sized and shaped to mate with the module or portion thereof, e.g., node-defining plate, so as to enclose the nodes and any CLCs accommodated therein. The lid may be openable and closeable by an automatic actuator, or may be manually operated. The lid can seal the carrier liquid into the vessel in order to inhibit evaporation of the carrier liquid. The lid can partially seal against the vessel, or it can be substantially airtight, maintaining a pressure seal. The lid can be transparent to any particularly desired wavelength of light, to allow for electromagnetic interrogation of the CLCs. A heating element can be included in the lid, as desired. The lid can be thermally controlled as desired, such that the temperature of the lid may be modulated to a desired value.

### Plate Locations

As summarized above, devices described herein include one or more plate locations. While the number of plate locations present in the device may vary, in some instances the device includes 1 to 10 plate locations, such as 2 to 8 plate locations, e.g., 6 plate locations. The plate location(s) may be arranged in any convenient manner in the device, where in some instances in which the device includes a plurality of plate locations, the plurality of plate locations are arranged adjacent to each other, e.g., in a portrait format relative to an entry port of the device. Plate locations are regions or areas of the device configured to hold a laboratory plate, such as a multi-well plate, e.g., a 96 or 384 multi-well plate, or analogous structure, e.g., a test tube holder or rack, etc. A given plate location may be a simple stage or support configured to hold a laboratory plate. While the dimensions of the plate locations may vary, in some instances the plate locations will have a planar surface configured to stably associate with a laboratory plate, where the planar surface may have an area ranging from 10 mm to 400 mm, such as 10 mm to 200 mm. The planar surface may have any convenient shape, e.g., circular, rectangular (including square), triangular, oval, etc., as desired. To provide for stable association between a plate location and a research plate, the plate location may include one or more stable association elements, e.g., clips, alignment posts, etc.

Examples of plate locations include, but are not limited to, the following: sample plate locations, barcode plate locations, reagent plate locations, adapter plate locations, purification reagent plate locations, and plate locations for hold one or more receptacles for receiving the final library product once produced.

In some instances, a plate location may be thermally modulated, by which is meant that the temperature of the plate location may be controllable, e.g., so as to control the temperature of a research plate (and the contents thereof) stably associated with the plate location. Any convenient temperature modulator may be employed to control the temperature of the plate location in a desired manner, where temperature modulators that may be employed include those described above in connection with the thermal chip module.

In some instances, a given plate location may be configured to be agitated, i.e., the plate location is a shaker unit. As such, it may include an agitator (e.g., vibrator or shaker component). While the frequency of the movement of the plate location provided by the agitator component may vary, in some instances that agitator may be configured to move the plate location between first and second positions at a frequency ranging from 1 rpm to 4000 rpm, such as 50 rpm to 2500 rpm, where the distance between the first and second positions may vary, and in some instances ranges from 10 mm to 400 mm, such as 25 mm to 100 mm.

### Robotically Controlled Liquid Handler

As summarized above, devices described herein include a robotically controlled liquid handler. The robotically controlled liquid handler is a unit that is configured to perform liquid transfer and liquid collection/purification processes in the device. For example, the robotically controlled liquid handler can be used to transfer liquid and/or CLCs between various locations of the device, such as the plate location(s) and the thermal chip module, as well as harvesting CLC samples for downstream manipulations (e.g., magnetic bead nucleic acid purification steps). In a general sense, the robotic liquid handler may be any liquid handling unit that is capable of transferring or manipulating a quantity of liquid in the device. Robotic liquid handlers of interest are ones that can remove a defined volume of liquid from a first location of the device, such as a well of a laboratory plate or a node of a thermal chip module, optionally process the sample (e.g., purify a desired component of a reaction), and deposit some or all of the liquid at second location of the device, e.g., a node of a thermal chip module or a product collection location. While the volume of liquid that the handler is configured to transfer may vary, in some instances the volume ranges from 100 nl to 10 ml, such as 100 nl to 1 ml.

Details regarding liquid handling systems that may be employed in the device are provided in PCT application Serial No. US/2015/015047 published as WO 2015/120398 and PCT application Serial No. PCT/IB2013/003145 published as WO 2014/08345; the disclosures of which are hereby incorporated by reference herein in their entirety.

In some instances, the robotic liquid handler includes a mover that can be selectively operatively coupled to a plurality of distinct interchangeable liquid manipulator heads, e.g., capillary heads, purification heads, etc. In such embodiments, the mover can be coupled and decoupled to a liquid manipulator head from a collection of two or more liquid manipulator heads, such that the liquid manipulator heads are interchangeable (i.e., can be substituted for one another) with the mover. Where the mover provides for modulated pressure, e.g., negative and/or positive pressure, to the liquid manipulator head when in use, the coupling configuration provides for the modulated (e.g., positive or negative) pressure to be coupled to the liquid manipulators, e.g., capillaries, of the head when coupled to the mover. The number of interchangeable liquid manipulator heads in the device may vary, ranging in some instances from 2 to 6, such as 2 to 4. The function of such interchangeable liquid manipulator heads may also vary, where in some instances the device includes interchangeable liquid manipulator heads configured for sample dispense, barcode dispense, reagent dispense, vacuum and purification tasks. The mover to which the interchangeable heads may be operatively coupled is a subunit of the device that is configured to move an interchangeable head between two or more locations of the device. The mover may be a robotic arm or other convenient structure that is configured to move a given interchangeable head in the X and/or Y and/or Z direction in the device.

In certain embodiments, the robotically controlled liquid handler includes a product purification system configured to aspirate and dispense reagents from multiple samples simultaneously. The product purification system includes a purification head having multiple channels and purification fluidic components. Balance of the fluidic restriction across the multiple fluidic channels of a purification head is necessary to maintain equal flow rate and prevent siphoning during no flow conditions. This restriction should be sufficiently large to ensure that any variation in tubing lengths and manifold manufacturing do not significantly impact the total fluidic restriction. In addition, providing sufficient fluidic restriction maintains the flow balance if the individual channels have variation in the multiphase fluidic column due to variations in other sub-assemblies. Non-limiting examples of fluidic restriction in fluid purification systems are provided below.

A schematic of certain components of a fluid purification system according one embodiment of the present disclosure are shown in FIG. 8, which includes a purification head (g) and purification fluidic components (elements (a) to (e)). Specifically, the fluid purification system of FIG. 8 includes a first manifold (d) configured to split the fluid conduit from an individual fluid pump (a) (e.g., a syringe pump) into multiple separate fluid channels. While the fluid conduit from (a) is split into 4 separate fluid channels in manifold (d) of FIG. 8, the manifold can be configured to split a conduit into any number of separate fluid channels, e.g., from 2 to 50 separate channels. Each of the separate fluid channels (e) from first manifold (d) are configured to have a large flow restriction as compared to the channels to/from the purification head (g) (or to have a flow restrictor in each of the multiple fluid channels). In certain embodiments, large flow restriction is achieved by using channels (e) in which the diameter is substantially smaller than the diameter of the channels to/from the purification head (g). In such embodiments, the flow restrictor is said to be small diameter tubing in each of the multiple fluid channels. The magnitude of inner diameter reduction between the purification head channels and the small diameter tubing may vary, ranging in some instances from 0.1 to 1.0 mm, such as 0.2 to 0.8 mm; where the inner diameter of the small diameter tubing ranges, in some instances, from 0.1 to 0.4 mm, such as 0.15 to 0.25 mm. In certain of these embodiments, the purification fluidic components can include a second 1-to-1 manifold that serves as an adapter to allow connection of fluid channels having substantially different diameters (see element (f) in FIG. 8). Using small diameter tubing to create the fluidic restriction in channels (e) requires careful quantification to ensure that the restrictions are adequately balanced across the multiple channels. Other flow restriction elements may be employed in the channels (e).

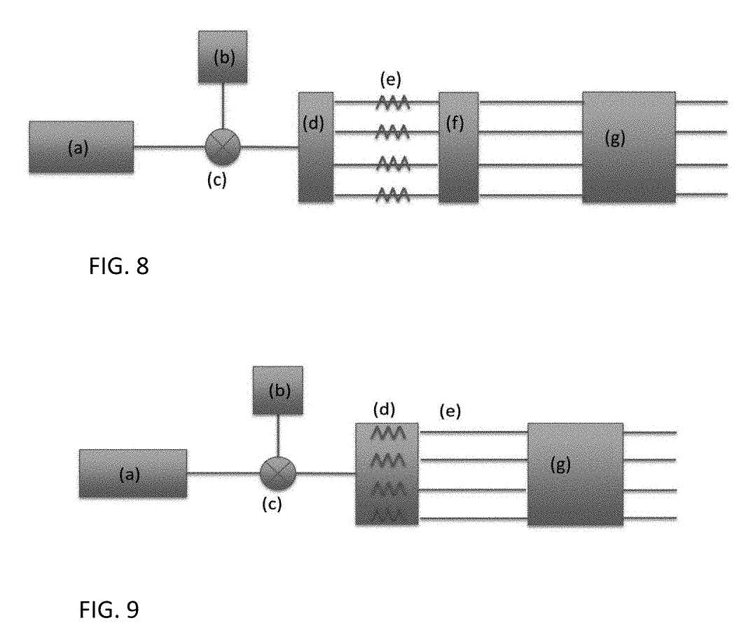

FIG. 9 shows an alternative flow restriction embodiment schematic. In this figure, manifold (d), which again is configured to split the fluid conduit from an individual syringe pump (a) into multiple separate channels (e), is configured to include flow restriction elements rather than the channels themselves. In one embodiment, manifold (d) includes orifice flow restrictors that generate the fluidic resistance necessary to balance the pressure in the multiple parallel channels. One specific example of an orifice restriction is Lee Co. part number RPLR2552450S orifice flow restrictor, which can be integrated into each channel emanating from manifold (d). While the diameter of the flow restrictors employed in embodiments of the invention may vary, in some instances the diameter ranges from 0.01 to 0.1 mm, including 0.02 to 0.08 mm. Similar to the use of small diameter tubing, the use of orifice restrictors adds uniformity to the fluidic restriction (due to the careful tolerancing of the orifice restrictor manufacturing). In addition, incorporating flow restrictors directly into manifold (d) removes the need for an additional 1-to-1 manifold (f) to connect channels having different diameters (as shown in FIG. 9).

Alternative flow restrictors can also be used in manifold (d), e.g., frit restrictors, to provide the benefits to the fluid purification system described above. In addition, fluid systems can include flow restriction elements in both manifold (d) (e.g., orifice flow restrictors) and channels (e) (e.g., small diameter tubing). No limitation in this regard is intended.

### Bulk Reagent Dispenser

Devices described herein further include a bulk reagent dispenser that is configured to deposit a metered volume of a desired reagent composition, e.g., a liquid reagent composition, into the nodes of the thermal chip module (e.g., a metered volume of a polymerase, nucleotide mix, primer, adapter, buffer, and/or a ligase, etc.). In some instances, the bulk reagent dispenser includes a reagent metering element (such as a liquid reagent metering unit) operatively coupled to a bulk reagent source (such as a liquid reagent reservoir, e.g., present in a cartridge) by an automated movement arm, e.g., an arm that is configured to move in the X and/or Y and/or Z directions. In some instances, the bulk reagent dispenser is configured to be able to individually introduce a metered amount of a reagent composition into a node and any CLC present therein in a non-contact microfluidic dispensing manner, e.g., by dropping an amount of the reagent composition onto a CLC in the node such that the reagent composition merges with the CLC in the node.

### Fluidics Module

Devices described herein further include a fluidics module that includes one or more liquid reservoirs, e.g., for system fluids, waste collection, etc. System fluids of interest include, but are not limited to, wash fluids, elution fluids, etc. Where desired, the waste collection reservoir is operatively coupled to a single waste drain.

### Additional Aspects

Devices described herein may be configured to automatically produce large numbers of libraries in a short period of time following commencement of a given library preparation run. The numbers of library samples that the devices may be configured to simultaneously produce ranges in some instances from 1 to 1000, such as 8 to 768, e.g., 96, 192, 384 or 768 libraries. While the amount of time required to produce such libraries may vary, in some instances the amount of time ranges from 1 hour to 48 hours, such as 2 to 36 hours, e.g., 6 hours.

To facilitate reagent handling and device set up, the device may include a control processor in operative communication with a handheld unique identifier (e.g., barcode) scanner, which scanner may communicate with the processor via a wired or wireless communication protocol. Such embodiments may be used to upload identifying information regarding laboratory plates and/or reagent sources into the control processor of the device in order configure the device to automatically perform a library preparation protocol.

### Methods of Use

Aspects of the invention include methods of producing a nucleic acid library from an initial nucleic acid sample by using a device of the invention, e.g., as described above, in a CLC-mediated library preparation protocol. Detailed description of nucleic acid library preparation steps are disclosed in U.S. Pat. No. 8,465,707, as well as United States Patent Publication Nos. 20140371107, 20150238920 and 20150283541; and PCT Application Publication Nos. WO 2014/188281; WO 2014/207577; WO2015/075563 and WO2015/075560; the disclosures of which are herein incorporated by reference.

In certain embodiments, the library produced is suitable for use in next generation sequencing (NGS) applications and analyses. As such, the devices of the invention may be employed to produce NGS libraries suitable for sequencing in a variety of different NGS platforms, including but not limited to: the HiSeq™, MiSeq™ and Genome Analyzer™ sequencing systems from Illumina®; the Ion PGM™ and Ion Proton™ sequencing systems from Ion Torrent™; the PACBIO RS II sequencing system from Pacific Biosciences, the SOLiD sequencing systems from Life Technologies™, the 454 GS FLX+ and GS Junior sequencing systems from Roche, or any other sequencing platform of interest.

In preparing an NGS library, a nucleic acid sample from which the library is to be prepared is first provided. Any convenient nucleic acid sample preparation method may be employed from any desired source of nucleic acids, including, but not limited to: deoxyribonucleic acids, e.g., genomic DNA, complementary DNA (or “cDNA”, synthesized from any RNA or DNA of interest), recombinant DNA (e.g., plasmid DNA); ribonucleic acids, e.g., messenger RNA (mRNA), a microRNA (miRNA), a small interfering RNA (siRNA), a transacting small interfering RNA (ta-siRNA), a natural small interfering RNA (nat-siRNA), a ribosomal RNA (rRNA), a transfer RNA (tRNA), a small nucleolar RNA (snoRNA), a small nuclear RNA (snRNA), a long non-coding RNA (IncRNA), a non-coding RNA (ncRNA), a transfer-messenger RNA (tmRNA), a precursor messenger RNA (pre-mRNA), a small Cajal body-specific RNA (scaRNA), a piwi-interacting RNA (piRNA), an endoribonuclease-prepared siRNA (esiRNA), a small temporal RNA (stRNA), a signal recognition RNA, a telomere RNA, a ribozyme; etc.

Once prepared, the nucleic acid sample, along with any other samples from which a nucleic acid library is to be prepared in a given run of the device, is placed into a well or analogous container of a sample plate and positioned on a sample plate location of the device, e.g., through an open access door to the main deck of the device. The device is also loaded with one or more laboratory plates comprising sample identifying nucleic acids (i.e., barcodes), purification magnetic beads, library product receptacles (e.g., configured to either maintain individual product libraries or pool two or more different product libraries), bulk reagent liquids, wash and purification fluids, CLC liquids, etc. In addition, the control instructions and data about a given run may be input into the device, e.g., by using an automated protocol (such as with a hand held barcode scanner) or manually via an appropriate user interface, etc. Control instructions may include the number of samples to be run, which may be input using any convenient protocol, e.g., via manually entered user data or a previously generated .csv file. Information to be input may further include the number of samples and location of samples.

The device may include a main user interface. Where desired, the main user interface provides feedback, e.g., through a display/graphical user interface (GUI), for run status information and/or status of components of the device; e.g., temperature of the thermal chip module, thermal fluid bath temperature(s), heating/cooling modes, carrier or bulk reagent fluid levels, etc.

Once the device is loaded with nucleic acid sample(s) and configured for a given nucleic acid library production run, the run is started. During the run, the device employs the robotically controlled liquid handling system to produce CLCs in the nodes of the thermal chip module(s) containing the desired nucleic acid samples, e.g., from 100 nl to 1 ml nucleic acid sample from one or more wells of a sample plate to one or more nodes of the thermal chip module having an a volume of encapsulating fluid therein. Details regarding CLC production methods which may be employed by the device are further described in U.S. Pat. No. 8,465,707, the disclosure of which is herein incorporated by reference.

The device then proceeds to control the temperature of the thermal chip module(s) and the addition of reagents to the CLCs in the nodes of the thermal chip module using the robotically controlled liquid handler according to a protocol input or selected by the user. Common reagents that may be dispensed into the different nodes by the bulk reagent dispenser include, but are not limited to: dNTPs (e.g., in the form of a mastermix), enzymes, e.g., polymerases, ligases, primers, platform specific sequencing adaptors (which may or may not be integrated with the primers), etc. In addition, sample identifiers, e.g., nucleic acid barcodes, may be added to the nodes to uniquely identify the CLCs by sample source.

Controlling the temperature of the thermal chip module during the library preparation program includes employing the improved components of the device as detailed above. Thus, in certain embodiments, the thermal chip module includes a thermal fluid tube array through which a thermal fluid at a desired temperature is flowed to control the temperature of the thermal chip module (e.g., cooling, heating or holding a desired temperature). In embodiments in which the thermal fluid tube array includes a first fluid inlet and a second fluid inlet and a first fluid outlet and a second fluid outlet, the method includes flowing a thermal fluid into the first and second fluid inlets and out of the first and second fluid outlets. The first and second fluid inlets and the first and second fluid outlets are configured such that the thermal fluid is flowed throughout the thermal tube array, and thereby providing the desired temperature control of the thermal chip module. The fluid inlets and outlets can be positioned as described above. For example, the first fluid inlet and the second fluid inlet can be positioned at opposite ends of a single row of the fluid tube array, e.g., an external row of the fluid tube array, and the first fluid outlet and the second fluid outlet can be positioned at the distal end of corresponding first and second columns of the fluid tube array. The first and second fluid outlets can be positioned on the same side of the thermal chip module. It is noted that the thermal tube array can include more than two inlets/outlets, e.g., from 3 to 20 inlets and/or outlets.

As described above the thermal fluid tube array can be operably connected to a fluid bath system configured to control the temperature of fluid flowing into the thermal fluid tube array. In certain embodiments, the fluid bath system includes a first cooling fluid bath maintained at a low temperature (e.g., from 10° C. to 30° C.) and a second thermal fluid bath operably coupled with the thermal fluid tube array that is maintained at temperature higher than the cooling fluid bath (e.g., from 55° C. to 95° C.). When used to cool the thermal chip module to a desired temperature, the method includes flowing cooling fluid from the first cooling fluid bath through the thermal fluid tube array of the thermal chip module to reduce the temperature of the thermal chip module to the desired temperature and then flowing a second fluid through the thermal fluid tube array of the thermal chip module the second fluid is at (or near) the desired temperature. In this configuration, the second fluid contains at least some of the thermal fluid from the second thermal fluid bath. Thus, the second fluid flowed through the thermal fluid tube array can be derived solely from the second thermal fluid bath or can be a mixture of thermal fluids from the first cooling fluid bath and the second thermal fluid bath. Mixing the thermal fluids can be done by an in-line mixer. In some cases, the inline mixer is operably connected to a thermal feedback control configured to control the proportion of fluids mixed by the inline mixer, e.g., based on the desired temperature of the thermal chip module.

In other embodiments, the fluid bath system includes a first cooling fluid bath maintained at a low temperature (e.g., from 10° C. to 30° C.) and a flow through heater operably coupled with the cooling fluid bath. When used to cool the thermal chip module to a desired temperature, the method includes flowing cooling fluid from the first cooling fluid bath through the thermal fluid tube array of the thermal chip module to reduce the temperature of the thermal chip module to the desired temperature and then flowing a second fluid through the thermal fluid tube array of the thermal chip module where the second fluid is at (or near) the desired temperature. The second fluid in this embodiment is thermal fluid from the first cooling thermal fluid bath that has been heated by the flow-through heater. Thus, the method includes heating cooling fluid from the cooling fluid bath to produce the second fluid.

It is noted here that any combination of multiple fluid baths, flow-through heaters, inline mixers, and controllers configured to control these elements can be employed in the thermal fluid bath system.

In some embodiments, the structure of the thermal chip module is modified to improve its thermal regulation. Thus, in certain embodiments, the thermal chip module has a substantially planar top surface and a dual-tapered bottom surface and/or is fabricated from a material having a different heat capacity, fabricating the thermal block material from copper rather than aluminum to provide thermal uniformity improvements.

In general, the devices describe herein use multichannel fluid handling components. For example, the devices disclosed herein include a fluid purification system that uses one or more purification head(s) having multiple channels and purification fluidic components. As such, the present disclosure provides methods for multi-channel fluid handling that include flowing fluid through a manifold using a fluid pump, where the manifold is configured to split a first fluid conduit from the fluid pump into multiple fluid channels, where each of the multiple fluid channels has a restricted flow, e.g., includes a flow restrictor. As detailed above, the manifold can be configured to split the first fluid conduit from the fluid pump into 4 or more fluid channels. In certain embodiments, restricting the flow in the channels can be achieved by using small diameter tubing for each of the multiple fluid channels (e.g., the diameter is substantially smaller than the diameter of the channels to/from the purification head; element (g) in FIG. 8). In such embodiments, the flow restrictor can be said to be small diameter tubing in each of the multiple fluid channels. In some embodiments, the flow restrictor is present in the manifold. For example, the flow restrictor can be selected from: an orifice flow restrictor and a frit flow restrictor.

Following production of a nucleic acid library in the CLCs of the nodes of the thermal chip modules (e.g., a barcoded nucleic acid library), the library may be purified using the fluid purification system of the device (e.g., as described above). While the library may be purified using any convenient protocol, in some instances a magnetic bead based purification protocol is employed. Details regarding magnetic bead/conduit based purification protocols that may be employed by the device are further described in PCT Application Serial No. PCT/IB2014/002159 published as WO 2014/207577. Further description can also be found in PCT application Serial No. US/2015/015047 published as WO 2015/120398 and entitled “Composite Liquid Cell (CLC) Mediated Nucleic Acid Library Preparation Device, and Methods for Using the Same”. Both of these applications are hereby incorporated by reference herein in their entirety.

The resultant product libraries may then be sequenced, as desired, using any convenient NGS sequencing platform, including: the HiSeq™, MiSeq™ and Genome Analyzer™ sequencing systems from Illumina®; the Ion PGM™ and Ion Proton™ sequencing systems from Ion Torrent™; the PACBIO RS II sequencing system from Pacific Biosciences, the SOLiD sequencing systems from Life Technologies™, the 454 GS FLX+ and GS Junior sequencing systems from Roche, or any other convenient sequencing platform.

### Computer Controllers

Aspects of the present disclosure further include computer controllers for operating the devices, where the controllers further include one or more computer elements for complete automation or partial automation of a device as described herein. In some embodiments, the controllers include a computer having a computer readable storage medium with a computer program stored thereon, where the computer program when loaded on the computer includes instructions for actuation the device to perform a CLC mediated nucleic acid library production protocol., e.g., as described above.

In embodiments, the controller includes an input module, a processing module and an output module. Processing modules of interest may include one or more processors that are configured and automated to implement one or more routines of the device, e.g., as described above. For example processing modules may include two or more processors, such as three or more processors, such as four or more processors and including five or more processors, configured and automated to produce a nucleic acid library. As described above, each processor includes memory having a plurality of instructions for performing the steps of the subject methods.

The controllers may include both hardware and software components, where the hardware components may take the form of one or more platforms, such that the functional elements, i.e., those elements of the controller that carry out specific tasks (such as managing input and output of information, processing information, etc.) of the controller may be carried out by the execution of software applications on and across the one or more computer platforms represented of the system.

Controllers may include a display and operator input device. Operator input devices may, for example, be a keyboard, mouse, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor or it may be one of other processors that are or will become available. The processor executes the operating system and the operating system interfaces with firmware and hardware in a well-known manner, and facilitates the processor in coordinating and executing the functions of various computer programs that may be written in a variety of programming languages, such as Java, Perl, C++, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques.

The system memory may be any of a variety of known or future memory storage devices. Examples include any commonly available random access memory (RAM), magnetic medium such as a resident hard disk or tape, an optical medium such as a read and write compact disc, flash memory devices, or other memory storage device. The memory storage device may be any of a variety of known or future devices, including a compact disk drive, a tape drive, a removable hard disk drive, or a diskette drive. Such types of memory storage devices typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

Memory may be any suitable device in which the processor can store and retrieve data, such as magnetic, optical, or solid state storage devices (including magnetic or optical disks or tape or RAM, or any other suitable device, either fixed or portable). The processor may include a general purpose digital microprocessor suitably programmed from a computer readable medium carrying necessary program code. Programming can be provided remotely to processor through a communication channel, or previously saved in a computer program product such as memory or some other portable or fixed computer readable storage medium using any of those devices in connection with memory. For example, a magnetic or optical disk may carry the programming, and can be read by a disk writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The processor may also have access to a communication channel to communicate with a user at a remote location. By remote location is meant the user is not directly in contact with the system and relays input information to an input manager from an external device, such as a computer connected to a Wide Area Network (“WAN”), telephone network, satellite network, or any other suitable communication channel, including a mobile telephone (i.e., smartphone).

In some embodiments, controllers according to the present disclosure may be configured to include a communication interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, WiFi, infrared, wireless Universal Serial Bus (USB), Ultra Wide Band (UWB), Bluetooth® communication protocols, and cellular communication, such as code division multiple access (CDMA) or Global System for Mobile communications (GSM).

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via system bus. Some of these communications may be accomplished in alternative embodiments using network or other types of remote communications. The output manager may also provide information generated by the processing module to a user at a remote location, e.g., over the Internet, phone or satellite network, in accordance with known techniques. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows NT®, Windows XP, Windows 7, Windows 8, iOS, Sun Solaris, Linux, OS/400, Compaq Tru64 Unix, SGI IRIX, Siemens Reliant Unix, and others.

Although the foregoing invention has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A complete nucleic acid library preparation device, the device comprising:
a thermal chip module comprising multiple nodes;
a plate location; and
a robotically controlled liquid handler configured to transfer liquid between the plate location and the thermal chip module;
wherein the device comprises one or more of:
(a) the robotically controlled liquid handler comprises a fluid pump operably coupled to a manifold, wherein the manifold is configured to split a first fluid conduit from the fluid pump into multiple fluid channels and comprises a flow restrictor for each of the multiple fluid channels;
(b) the thermal chip module comprises a substantially planar top surface and an inwardly tapered bottom surface; and
(c) the thermal chip module comprises a thermal fluid tube array, wherein:
(i) the thermal fluid tube array comprises a first fluid inlet and a second fluid inlet and a first fluid outlet and a second fluid outlet; and/or
(ii) the thermal fluid tube array is operably connected to a fluid bath system configured to control the temperature of fluid flowing into the thermal fluid tube array, wherein the fluid bath system comprises a cooling fluid bath and:
(1) a second thermal fluid bath operably coupled with the thermal fluid tube array, wherein the second thermal fluid bath is maintained at temperature higher than the cooling fluid bath; and/or
(2) a flow through heater operably coupled with the cooling fluid bath.

2. The device according to claim 1, wherein the robotically controlled liquid handler comprises a fluid pump operably coupled to a manifold, wherein the manifold is configured to split a first fluid conduit from the fluid pump into multiple fluid channels, wherein each of the multiple fluid channels comprises a flow restrictor.

3. The device according to claim 2, wherein the manifold is configured to split the first fluid conduit from the fluid pump into at least 4 fluid channels.

4. The device according to claim 2, wherein the flow restrictor is small diameter tubing in each of the multiple fluid channels.

5. The device according to claim 2, wherein the flow restrictor is present in the manifold.

6. (canceled)

7. The device according to claim 1, wherein the thermal chip module comprises a substantially planar top surface and an inwardly tapered bottom surface.

8. The device according to claim 1, wherein the thermal chip module comprises a thermal fluid tube array.

9. The device according to claim 8, wherein the thermal fluid tube array comprises a first fluid inlet and a second fluid inlet and a first fluid outlet and a second fluid outlet, wherein the first and second fluid inlets and outlets are configured to flow a thermal fluid throughout the entire thermal fluid array from the first and second inlets to the first and second outlets.

10. The device according to claim 9, wherein the first fluid inlet and the second fluid inlet are positioned at opposite ends of a single row of the fluid tube array.

11. The device according to claim 10, wherein the single row is an external row of the fluid tube array.

12. The device according to claim 9, wherein the first fluid outlet and the second fluid outlet are positioned at the distal end of corresponding first and second columns of the fluid tube array.

13. The device according to claim 12, wherein the first and second fluid outlets are positioned on the same side of the thermal chip module.

14. The device according to claim 8, wherein the thermal fluid tube array is operably connected to a fluid bath system configured to control the temperature of fluid flowing into the thermal fluid tube array, wherein the fluid bath system comprises a cooling fluid bath and a second thermal fluid bath and the second thermal fluid bath is maintained at temperature higher than the cooling fluid bath.

15. The device according to claim 14, further comprising a controller configured to control fluid flow from the cooling fluid bath and the second thermal fluid bath to the thermal fluid tube array based on a target temperature for the thermal chip module.

16. The device according to claim 14, further comprising an inline mixer configured to mix fluids from the cooling fluid bath and the second thermal fluid bath prior to entering the thermal fluid tube array.

17. The device according to claim 16, further comprising a thermal feedback control configured to control the proportion of fluids mixed by the inline mixer based on the target temperature for the thermal chip module.

18-20. (canceled)

21. The device according to claim 14, further comprising a flow through heater operably coupled with the fluid bath system configured to heat fluid from the cooling fluid bath and/or fluid from the second fluid bath prior to entering the fluid tube array.

22. The device according to claim 14, wherein the thermal fluid tube array is operably connected to a fluid bath system configured to control the temperature of fluid flowing into the thermal fluid tube array, wherein the fluid bath system comprises a cooling fluid bath and a flow through heater configured to heat fluid from the cooling fluid bath prior to entering the fluid tube array.

23. (canceled)

24. A method of producing a nucleic acid library from an initial nucleic acid sample, the method comprising:
introducing the nucleic acid sample into a device according to claim 1; and
obtaining the nucleic acid library from the device.

25-27. (canceled)

28. A method for multi-channel fluid handling, the method comprising flowing fluid through a manifold using a fluid pump, wherein the manifold is configured to split a first fluid conduit from the fluid pump into multiple fluid channels and the manifold comprises a flow restrictor for each of the multiple fluid channels.

29-45. (canceled)
